(19) United States
(12) Patent Application Publication
(10) Pub. No.: US 2009/0168134 A1
(43) Pub. Date: Jul. 2, 2009

(54) IMAGE DISPLAY APPARATUS

(75) Inventor: Shigeo NOJIMA, Suwa-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/340,928

(22) Filed: Dec. 22, 2008

(30) Foreign Application Priority Data
Dec. 28, 2007 (JP) 2007-339461

(51) Int. Cl. G02B 26/10

(52) U.S. Cl. 359/214.1

(57) ABSTRACT

An image display apparatus includes a laser light source that emits laser light, a focusing optical system that focuses the laser light emitted from the laser light source, a scanner that scans the light that has exited from the focusing optical system to form an intermediate image, a divergent angle converter on which the intermediate image is formed, the divergent angle converter enlarging the divergent angle of the incident laser light and outputting the laser light with the enlarged divergent angle, and a projection element that projects the laser light that has exited from the divergent angle converter toward a surface on which the laser light is projected. The focusing optical system focuses the laser light onto the divergent angle converter.

### BACKGROUND

1. Technical Field

The present invention relates to an image display apparatus.

2. Related Art

In recent years, as there is an increasing demand to reduce the size of projectors, projectors using laser light sources have been developed in association with increase in output of semiconductor lasers and the advent of blue semiconductor lasers. A projector of this type has high potential as a next-generation display device, because a narrow wavelength band of the light source allows the color reproduction range to be sufficiently broad and size reduction and a reduced number of components are possible.

However, when a projector using a laser light source displays an image using image light, there occurs in some cases a phenomenon called “scintillation (also called “speckle”)” in which a screen or other scatterers cause light interference and bright and dark dots are distributed in a stripe pattern or a patch pattern.

Scintillation gives sense of glare to a viewer, gives sense of discomfort when the viewer looks at an image, and causes other adverse effects. In particular, highly coherent laser light likely causes scintillation. In a lamp-based light source as well, scintillation removal technology is important because recent arc length reduction technology produces higher coherency. In view of such circumstances, a technology for reducing speckle noise has been proposed (JP-A-2006-53495, for example).

The image display system described in JP-A-2006-53495 has a light source, a collimator lens, a scanner, a first optical system, a light diffusion angle converter, and a second optical system sequentially disposed therein. In the configuration, light from the light source is collimated by the collimator lens, scanned by the scanner, and focused by the first optical system to form an intermediate image. The intermediate image is formed on the light diffusion angle converter. The light diffusion angle converter enlarges the angle of incidence of the incident light and outputs the intermediate image with the enlarged exit angle. The light diffused in the light diffusion angle converter is projected on a screen by the second optical system. Oscillating light in the light diffusion angle converter as described above allows temporal change in speckle pattern to be integrated in human eyes and hence speckle noise to be reduced.

In the image display system described in JP-A-2006-53495, however, the collimator lens needs to be aligned with the first optical system with high precision. Assembling is thus complicated in the image display system of related art, resulting in a higher cost. Further, forming an intermediate image and then diffusing it greatly reduces the efficiency in using the light emitted from the light source as compared to a case where an image is directly drawn on the screen.

### SUMMARY

An advantage of some aspects of the invention is to provide a low-cost image display apparatus capable of improving the efficiency of light usage.

To achieve the above advantage, the invention provides the following aspects.

An image display apparatus according to an aspect of the invention includes a laser light source that emits laser light, a focusing optical system that focuses the laser light emitted from the laser light source, a scanner that scans the light that has exited from the focusing optical system to form an intermediate image, a divergent angle converter on which the intermediate image is formed, the divergent angle converter enlarging the divergent angle of the incident laser light and outputting the laser light with the enlarged divergent angle, and a projection element that projects the laser light that has exited from the divergent angle converter toward a surface on which the laser light is projected. The focusing optical system focuses the laser light onto the divergent angle converter.

In the image display apparatus according to the above aspect of the invention, the laser light emitted from the laser light source is focused by the focusing optical system onto the divergent angle converter. The laser light that has exited from the focusing optical system is scanned by the scanner to form an intermediate image on the divergent angle converter. The laser light that has formed the intermediate image on the divergent angle converter exits therethrough with a divergent angle larger than the divergent angle of the laser light incident on the divergent angle converter. The laser light that has formed the intermediate image and exited through the divergent angle converter is projected through the projection element on the surface on which the laser light is projected.

That is, unlike the related art in which an optical system provided between the scanner and the divergent angle converter forms an intermediate image, in the above aspect of the invention, the focusing optical system forms an intermediate image. It is thus possible to reduce the loss of the laser light scanned by the scanner and hence improve the efficiency in using the laser light scanned by the scanner. It is thus not necessary to increase the output intensity of the laser light emitted from the laser light source, whereby the electric power consumption can be reduced.

Further, according to the above aspect of the invention, unlike the related art, an intermediate image is not formed by an optical system provided between the scanner and the divergent angle converter, whereby the number of parts can be reduced and hence the cost can be reduced. Moreover, in the above aspect of the invention, since the number of optical members is fewer, optical axis alignment involving the optical members (the focusing optical system and other optical systems) can be readily carried out. Therefore, the overall apparatus can be readily assembled, whereby the cost can be reduced.

Since the laser light emitted from the laser light source is diffused in the divergent angle converter in such a way that the divergent angle of the laser light that exits from the divergent angle converter is larger than the divergent angle of the laser light incident on the divergent angle converter, the granularity of speckle noise can be reduced. In this way, generation of glare (scintillation and speckle) is reduced, because a speckle pattern having a finer granularity is more readily made uniform than a speckle pattern having a coarser granularity.

In the image display apparatus according to the above aspect of the invention, it is preferable that the divergent angle converter moves in the direction perpendicular to the central axis of the incident laser light.

In the image display apparatus according to the above aspect of the invention, the divergent angle converter moves in the direction perpendicular to the central axis of the incident laser light. The laser light that has exited from the divergent angle converter is thus integrated over time, whereby speckle noise can be reduced. Further, since the divergent angle converter moves in the direction perpendicular to the central axis of the incident laser light, it is ensured that the intermediate image on the divergent angle converter is conjugate to the image focused on the surface on which the laser light is projected. A sharp image can thus be projected without image blurring on the surface on which the laser light is projected.

It is preferable that the image display apparatus according to the above aspect of the invention further includes a deflector that deflects laser light in such a way that the laser light that exits from the divergent angle converter is oriented toward the optical axis of the projection element.

In the image display apparatus according to the above aspect of the invention, the deflector deflects laser light in such a way that the laser light that exits from the divergent angle converter is oriented toward the optical axis of the projection element. It is thus possible to prevent the laser light from not entering the projection element. That is, the deflector can narrow the irradiated area of the projection element where the laser light is incident in accordance with the size of the aperture of the projection element. The laser light can thus be reliably introduced into the projection element, whereby the efficiency of light usage can be improved.

Since the irradiated area of the projection element where the laser light is incident can be narrowed, the projection element does not need to have a large aperture. Since the projection element does not need to have a large aperture, the size of the overall apparatus can be reduced.

In the image display apparatus according to the above aspect of the invention, it is preferable that the deflector deflects the laser light in such a way that laser light incident on a position farther apart from the optical axis of the deflector is deflected more steeply toward the optical axis of the projection element.

In the image display apparatus according to the above aspect of the invention, the deflector deflects the laser light in such a way that laser light incident on a position farther apart from the optical axis of the deflector is deflected more steeply toward the optical axis of the projection element. In this way, the laser light that has exited from the divergent angle converter can be more efficiently introduced into the projection element.

In the image display apparatus according to the above aspect of the invention, it is preferable that the deflector is disposed between the scanner and the divergent angle converter.

When the deflector is disposed downstream of the divergent angle converter, the divergent angle converter enlarges the divergent angle of the laser light and outputs the laser light with the enlarged divergent angle, which is then deflected toward the optical axis of the projection element. In this configuration, since the deflector needs to be large enough to receive the laser light diffused in the divergent angle converter, the apparatus becomes disadvantageously large. In the image display apparatus according to the above aspect of the invention, since the deflector is disposed between the scanner and the divergent angle converter, the laser light is deflected toward the optical axis of the projection element before diffused in the divergent angle converter and exits therefrom. The size of the deflector can therefore be reduced as compared to a case where the deflector is disposed downstream of the divergent angle converter, whereby the size of the overall apparatus can be reduced.

In the image display apparatus according to the above aspect of the invention, it is preferable that the deflector is a lens system.

In the image display apparatus according to the above aspect of the invention, the lens system focuses the laser light before the divergent angle converter enlarges the divergent angle of the laser light and outputs the resultant laser light. The lens system can therefore reliably deflect laser light in such a way that the laser light that exits from the divergent angle converter is oriented toward the optical axis of the projection element. Further, when the lens system is disposed, for example, between the scanner and the divergent angle converter, the lens system does not need to have a large aperture, whereby the size of the apparatus can be reduced.

In the image display apparatus according to the above aspect of the invention, it is preferable that the deflector is disposed in such a way that the irradiated area of the projection element that is irradiated with the laser light that has exited from the divergent angle converter is sized to substantially fill the aperture of the projection element.

In the image display apparatus according to the above aspect of the invention, the deflector is disposed in such a way that the irradiated area of the projection element that is irradiated with the laser light that has exited from the divergent angle converter is sized to substantially fill the aperture of the projection element. In such a configuration, the laser light incident on the projection element will not be wasted, whereby the efficiency of light usage can be improved. Further, positioning the deflector in accordance with the size of the aperture of the projection element allows the size of the irradiated area of the projection element that is irradiated with the laser light to be adjusted. The projection element therefore does not need to have a large aperture, whereby the size of the overall apparatus can be reduced.

In the image display apparatus according to the above aspect of the invention, it is preferable that the divergent angle converter is integrated with the deflector.

In the image display apparatus according to the above aspect of the invention, since the divergent angle converter is integrated with the deflector, the size of the overall apparatus can be reduced. Further, since there is no interface between the divergent angle converter and the deflector, stray light will not be generated.

In the image display apparatus according to the above aspect of the invention, it is preferable that the divergent angle converter is a hologram element.

In the image display apparatus according to the above aspect of the invention, the divergent angle converter is a hologram element. An example of the hologram element may be a computer generated hologram (hereinafter referred to as CGH) in which protrusions and depressions artificially created through computation are formed in a glass substrate. Such a CGH is a wavefront converter that converts the wavefront of incident light using the diffraction phenomenon. In particular, a phase encoded CGH can perform wavefront conversion with nearly all the energy of incident light waves left. A CGH, which can thus produce a uniform intensity distribution or a simply shaped intensity distribution, can be preferably used in the image display apparatus. Further, a CGH allows a diffraction grating to be divided into arbitrary areas, and hence can be preferably used without aberrations.

When the divergent angle converter is integrated with the deflector, a hologram element having both the functions of the divergent angle converter and the deflector may be fabricated.

### BRIEF DESCRIPTION OF THE DRAWINGS

The invention will now be described with reference to the accompanying drawings, wherein like numbers reference like elements.

FIG. 1 is a plan view showing an image display apparatus according to a first embodiment of the invention.

FIG. 2 is a cross-sectional view showing a scanner shown in FIG. 1.

FIG. 3 is a plan view diagrammatically showing laser light that irradiates a divergent angle converter shown in FIG. 1.

FIG. 4 is a perspective view showing a variation of the image display apparatus according to the first embodiment of the invention.

FIG. 5 is a plan view showing an image display apparatus according to a second embodiment of the invention.

FIG. 6 is an enlarged plan view showing part of the image display apparatus shown in FIG. 5.

FIG. 7 is a plan view showing a principal ray that enters and exits from a divergent angle converter shown in FIG. 5.

FIG. 8 is a plan view showing an image display apparatus according to a third embodiment of the invention.

### DESCRIPTION OF EXEMPLARY EMBODIMENTS

Embodiments of an image display apparatus according to the invention will be described below with reference to the drawings. In the following drawings, the scale of each member is changed as appropriate in order to show the member at a recognizable size.

### First Embodiment

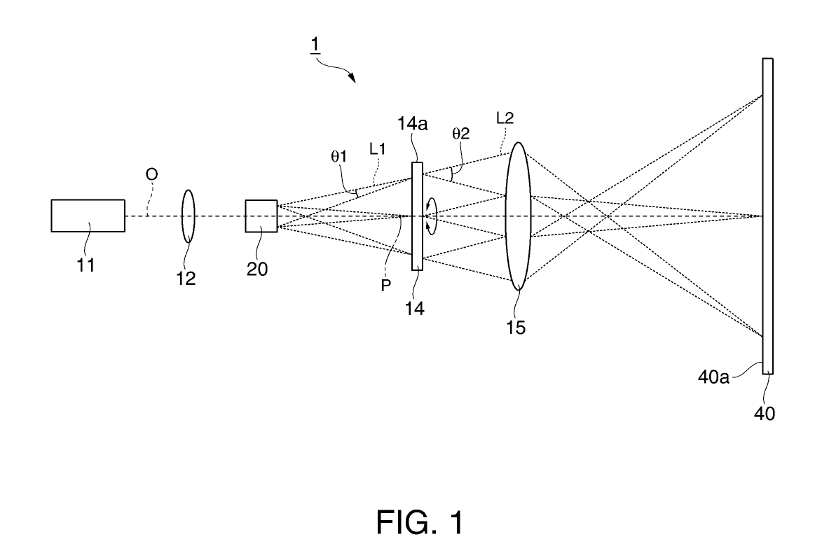

An image display apparatus 1 according to the present embodiment includes, as shown in FIG. 1, a laser light source 11, a focusing lens (focusing optical system) 12, an MEMS mirror (scanner) 20, a light diffuser (divergent angle converter) 14, and a projection lens (projection element) 15. The image display apparatus 1 displays an image by using the MEMS mirror 20 to scan laser light emitted from the laser light source 11 and orient the scanned laser light toward a screen (a surface on which the laser light is projected) 40.

The laser light source 11 is a single-mode laser diode that emits red laser light.

The focusing lens 12 focuses the laser light emitted from the laser light source 11 onto the light diffuser 14. That is, the focusing lens 12 focuses the laser light emitted from the laser light source 11 onto an incident end 14a of the light diffuser 14 so that the size of the focused light becomes that of the beam waist. In the present embodiment, a lens with a long depth of focus is used as the focusing lens 12. The position where the intermediate image is formed is not limited to the incident end 14a of the light diffuser 14, but may be a position in the vicinity of the incident end 14a.

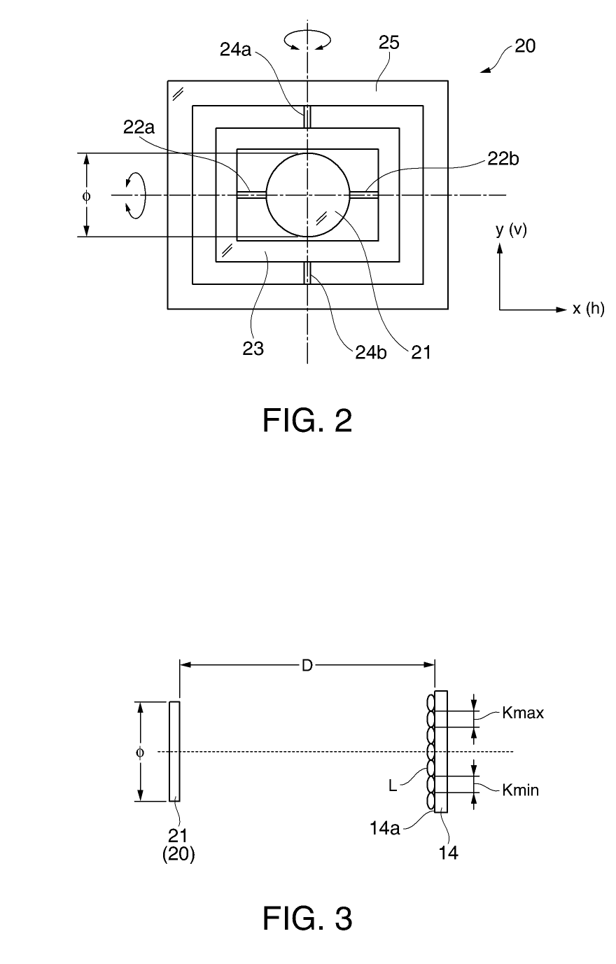

The MEMS mirror 20 scans the laser light that has exited from the focusing lens 12 to form an intermediate image on the incident end 14a of the light diffuser 14. The MEMS mirror 20 is a resonant mirror including a mirror portion (vertical scan portion) 21, beams 22a and 22b, a first substrate (horizontal scan portion) 23, beams 24a and 24b, and a second substrate 25, as shown in FIG. 2.

The mirror portion 21 is provided at a central portion of the MEMS mirror 20 and reflects the incident laser light toward the screen 40. The beams 22a and 22b are provided on respective sides of the mirror portion 21 and extend along a first direction. In the present embodiment, the first direction is the horizontal direction (direction h) on the screen 40.

The first substrate 23 has a frame-like shape that surrounds the mirror portion 21, and is connected to the beams 22a and 22b. The beams 24a and 24b are provided on respective sides of the first substrate 23 and extend along a second direction substantially perpendicular to the first direction. In the present embodiment, the second direction is the vertical direction (direction v) on the screen 40.

The second substrate 25 has a frame-like shape that surrounds the first substrate 23, and is connected to the beams 24a and 24b.

Such a configuration allows the mirror portion 21 to oscillate relative to the first substrate 22 around the beams 22a and 22b, which serve as an oscillation axis, and the first substrate 23 to oscillate relative to the second substrate 25 around the beams 24a and 24b, which serve as another oscillation axis. The MEMS mirror 20 can therefore oscillate around two axes, x and y axes, that is, the mirror portion 21 scans the laser light emitted from the laser light source 11 in the vertical direction on the screen 40, and the first substrate 23 scans the laser light emitted from the laser light source 11 in the horizontal direction on the screen 40.

In the present embodiment, as shown in FIG. 2, since the diameter φ of the mirror portion 21 of the MEMS mirror 20 is sufficiently larger than the beam diameter of the laser light focused by the focusing lens 12 and incident on the mirror portion 21, the optical path length from the focusing lens 12 to the beam waist (the incident end 14a of the light diffuser 14) when the MEMS mirror 20 is disposed between the focusing lens 12 and the light diffuser 14 is substantially the same as that when no MEMS mirror 20 is disposed.

Since the MEMS mirror 20 oscillates around the x and y axes, the scan angle by which the incident light is scanned changes with time. The change in the scan angle therefore slightly changes the optical distance from the focusing lens 12 to the light diffuser 14. However, since the focusing lens 12 has a relatively long depth of focus, the beam diameter of the laser light that irradiates the incident end 14a of the light diffuser 14 substantially remains unchanged even when the optical distance varies as the scan angle changes.

The focusing lens 12 will be described with reference to FIG. 3. In FIG. 3, laser light (one pixel) L that forms an intermediate image is diagrammatically shown on the incident end 14a of the light diffuser 14. The “pixel” used herein is an irradiated area on the light diffuser 14 that corresponds to a single pixel that is the minimum unit that forms an image projected on the screen 40.

First, assume the size of the intermediate image to be one inch, the screen resolution to be 800 by 600, and the diameter φ of the mirror portion 21 to be 4 mm. Also assume the optical distance D between the MEMS mirror 20 and the incident end 14a of the light diffuser 14 (intermediate image) to be 75 mm. Under such conditions, the focusing lens 12 to be used is designed in such a way that the ratio of the maximum diameter (Kmax) to the minimum diameter (Kmin) of the spot size of the laser light beam L that forms an intermediate image on the incident end 14a of the light diffuser 14 is approximately 1.06.

The diameter φ of the mirror portion 21 is set to 4 mm and the optical distance D is set to 75 mm only by way of example.

The focusing lens 12 having a long depth of focus can thus increase the area where the output intensity of the focused laser light emitted from the laser light source 11 is maintained at a high value.

The light diffuser 14 enlarges the divergent angle of the laser light focused by the focusing lens 12 and incident on the incident end 14a and outputs the formed intermediate image with the enlarged exit angle. Specifically, as shown in FIG. 1, the light diffuser 14 enlarges the divergent angle θ1 of the laser light L1 incident on the incident end 14a and converts the laser light L1 into exiting laser light L2 having a divergent angle θ2.

Further, the light diffuser 14 can move in the direction perpendicular to the central axis O of the laser light emitted from the laser light source 11, that is, can rotate around the axis of rotation P, which coincides with the central axis O. When the light diffuser 14 rotates approximately at 60 Hz, the viewer hardly perceives speckle noise. The rotation speed of the light diffuser 14 is not limited to 60 Hz, but may be set to any frequency higher than the frequency of flicker perceptible to a human, for example, 30 Hz or higher.

The projection lens 15 projects the laser light diffused in the light diffuser 14 toward the screen 40. The incident end 14a of the light diffuser 14 is conjugate to a surface 40a of the screen 40, whereby the projection lens 15 projects the intermediate image formed on the incident end 14a of the light diffuser 14 into an image on the surface 40a of the screen 40.

A description will be made of a method for projecting an image on the screen 40 by using the thus configured image display apparatus 1 of the present embodiment.

The laser light emitted from the laser light source 11 is focused by the focusing lens 12 and scanned by the MEMS mirror 20 in the horizontal and vertical directions. The laser light reflected off the MEMS mirror 20 forms an intermediate image on the incident end 14a of the light diffuser 14. The laser light incident on the light diffuser 14 exits with a divergent angle θ2 larger than the divergent angle θ1 of the incident laser light. The laser light that has exited from the light diffuser 14 is then projected on the screen 40 through the projection lens 15.

Since the light diffuser 14 rotates around the axis of rotation P, the scattered state of the laser light that exits from the light diffuser 14 changes with time. The speckle pattern of the laser light that has exited from the light diffuser 14 is integrated because of an after-image effect, whereby the resultant laser light has reduced scintillation. A sharp image is thus projected on the screen 40.

In the image display apparatus 1 according to the present embodiment, since the laser light emitted from the laser light source 11 is diffused in the light diffuser 14 in such a way that the divergent angle θ2 of the laser light that exits from the light diffuser 14 is larger than the divergent angle θ1 of the laser light incident on the light diffuser 14, the granularity of the speckle noise can be reduced. In this way, the laser light that forms an image projected on the screen 40 has a lower degree of coherency, because a speckle pattern having a finer granularity is more readily made uniform than a speckle pattern having a coarser granularity. A sharp image with less glare (scintillation and speckle) is thus projected on the screen 40.

Further, unlike the related art in which an optical system provided between the MEMS mirror 20 and the light diffuser 14 forms an intermediate image, in the present embodiment, the focusing lens 12 forms an intermediate image. It is thus possible to reduce the loss of the laser light scanned by the MEMS mirror 20 and hence improve the efficiency in using the laser light scanned by the MEMS mirror 20. It is thus not necessary to increase the output intensity of the laser light emitted from the laser light source 11, whereby the electric power consumption can be reduced.

Further, according to embodiments of the invention, unlike the related art, an intermediate image is not formed by an optical system provided between the MEMS mirror 20 and the light diffuser 14, whereby the number of parts can be reduced and hence the cost can be reduced. Moreover, in the present embodiment, since the number of optical members, such as the focusing lens 12, is fewer, optical axis alignment involving the focusing lens 12 and other optical members can be readily carried out. Therefore, the overall apparatus can be readily assembled, whereby the cost can be reduced.

That is, the image display apparatus 1 of the present embodiment allows the cost to be reduced and the efficiency of light usage to be improved.

Since the light diffuser 14 is rotated around the axis of rotation P, the laser light that has exited from the light diffuser 14 is integrated over time, whereby speckle noise can be reliably reduced. Further, the light diffuser 14 will not shift from the position where an intermediate image is focused (the position of the beam waist), whereby a sharp image can thus be projected on the screen 40 without image blurring.

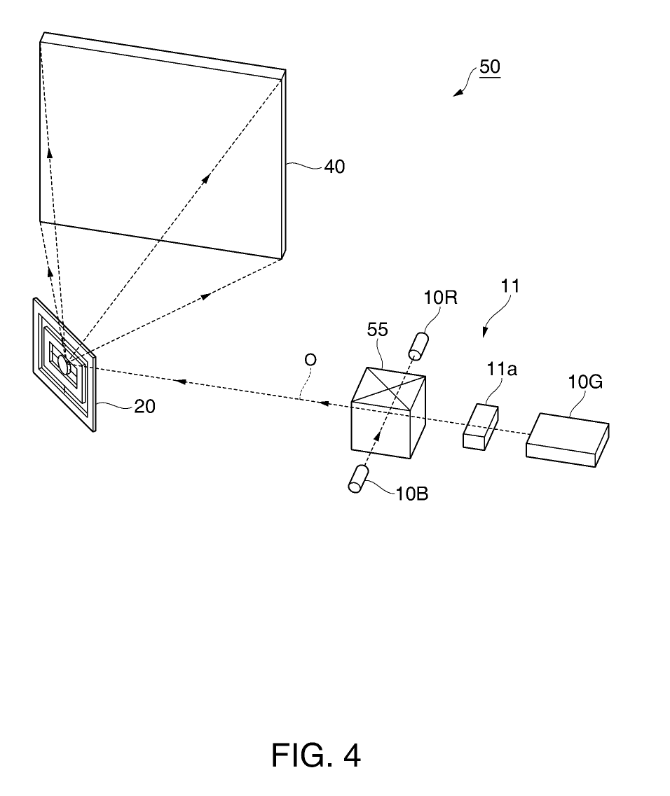

In the present embodiment, a monochromatic light source that emits red laser light is used as the laser light source 11, but three color light sources, a red light source 10R, a green light source 10G, and a blue light source 10B, may be used as the laser light source 11 along with a dichroic prism (color light combiner) 55 to form an image display apparatus 50 in which the red laser light, the green laser light, and the blue laser light are combined in the dichroic prism 55. The image display apparatus 50 includes, as shown in FIG. 4, the red light source 10R that emits red laser light, the green light source 10G that emits green laser light, the blue light source 10B that emits blue laser light, and an AOM (Acousto-Optic Modulator) 11a.

The red light source 10R is a semiconductor laser (LD) that emits red laser light having a central wavelength of 630 nm, and the blue light source 10B is a semiconductor laser (LD) that emits blue laser light having a central wavelength of 430 nm. The green light source 10G is comprised of a DPSS (Diode Pumping Solid State) laser, and a wavelength converter (not shown) is used to convert the laser light from the DPSS laser into green laser light having a central wavelength of 540 nm.

The AOM 11a is provided between the green light source 10G and the cross-dichroic prism 55. The AOM 11a is disposed to transmit the laser light emitted from the green light source 10G. When a high-frequency signal is inputted to the AOM 11a, supersonic waves according to the high-frequency signal propagates through the AOM 11a, and the resultant acousto-optic effect acts on the laser light passing through the AOM 11a. The acousto-optic effect causes diffraction, which causes laser light having the amount of light (intensity) according to the inputted high-frequency signal to exit from the AOM 11a as diffracted light. It is noted that the configuration of each of the light sources is not limited to the one described above.

As described above, the red light source 10R, the green light source 10G, and the blue light source 10B can be used to display a full-color image with reduced speckle noise on the screen 40.

The cross-dichroic prism 55 is used as the color light combiner, but the color light combiner is not limited thereto. For example, dichroic mirrors may be disposed to be inclined to one another so that color light beams are combined, or dichroic mirrors are disposed to be parallel to one another so that color light beams are combined.

The MEMS mirror 20, which performs double-axis scan, the horizontal scan and vertical scan, is used as the scanner, but a horizontal scanner that performs horizontal scan and a vertical scanner that performs vertical scan may be separately provided. When horizontal and vertical scanners are separately provided, the optical distance D between the scanner on the laser light source 11 side and the light diffuser 14 is set to 75 mm, and the diameter φ of the scanner is set to 4 mm. In this configuration again, as in the present embodiment described above, the focusing lens 12 to be used may be designed in such a way that the ratio of the maximum diameter (Kmax) to the minimum diameter (Kmin) of the spot size of the laser light beam L that forms an intermediate image on the incident end 14a of the light diffuser 14 is approximately 1.06.

While the light diffuser 14 is rotated around the central axis O of the laser light emitted from the laser light source 11 in the above description, the light diffuser 14 may be rotated around an axis parallel to the central axis O. For example, the light diffuser 14 may be rotated around an axis passing through an end thereof (where no laser light is incident). In the present embodiment, since the axis of rotation P passes through the position on which the laser light is incident, there could be a dead point (where there is no motion). To address the problem, rotating the light diffuser 14 around an axis passing through an end thereof as the axis of rotation P produces no dead point, whereby speckle noise can be reliably eliminated.

Alternatively, the light diffuser 14 may not be rotated. Since no rotation mechanism is necessary in such a configuration, the number of parts can be reduced and hence the cost of the apparatus can be reduced. Still alternatively, instead of rotating the light diffuser 14, the light diffuser 14 may be swung (moved) in the direction perpendicular to the central axis O of the laser light. In such a configuration, as in the case where the light diffuser 14 is rotated, speckle noise can be more reliably reduced. It is further ensured that the intermediate image on the light diffuser 14 is conjugate to the image focused on the screen 40. A sharp image can thus be projected on the screen 40 without image blurring.

### Second Embodiment

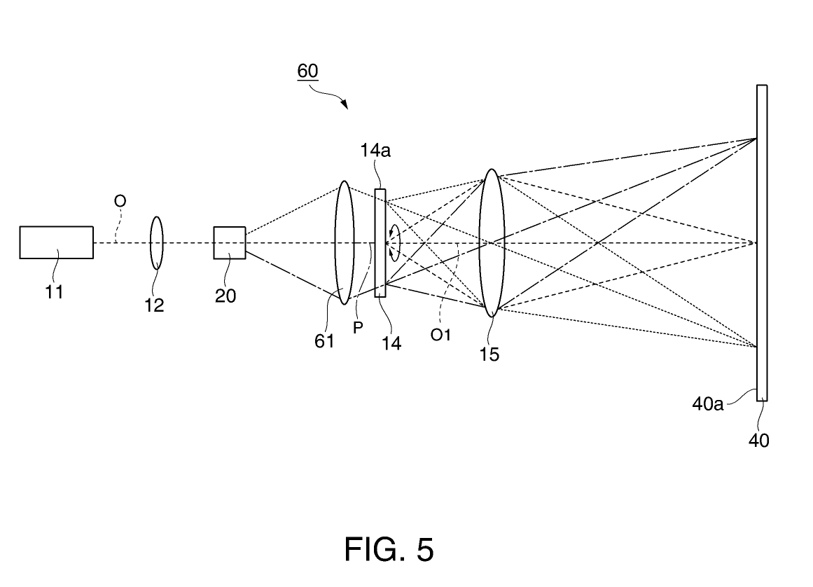

A second embodiment according to the invention will be described with reference to FIGS. 5 to 7. In the drawings of the embodiments described below, the same portions as those in the image display apparatus 1 according to the first embodiment described above have the same reference characters, and no description will be made.

An image display apparatus 60 according to the present embodiment is similar to the first embodiment but differs therefrom in that the image display apparatus 60 includes a focusing lens system 61.

The focusing lens system (deflector) 61 is disposed between the MEMS mirror 20 and the light diffuser 14, as shown in FIG. 5. The focusing lens system 61 deflects laser light in such a way that the laser light that forms an intermediate image and exits from the light diffuser 14 is oriented toward the optical axis O1 of the projection lens 15.

FIG. 5 shows a single lens as the focusing lens system 61, but the configuration of the focusing lens system 61 is not limited thereto. The focusing lens system 61 may be comprised of two or more lenses. Further, the focusing lens system 61 is not limited to a convex lens, but may be a combination of a convex lens and a concave lens. The shape of the lens that forms the focusing lens system 61 and the size of the aperture of the lens can be changed as appropriate in accordance with the incident laser light, the shape of the projection lens 15, and other factors.

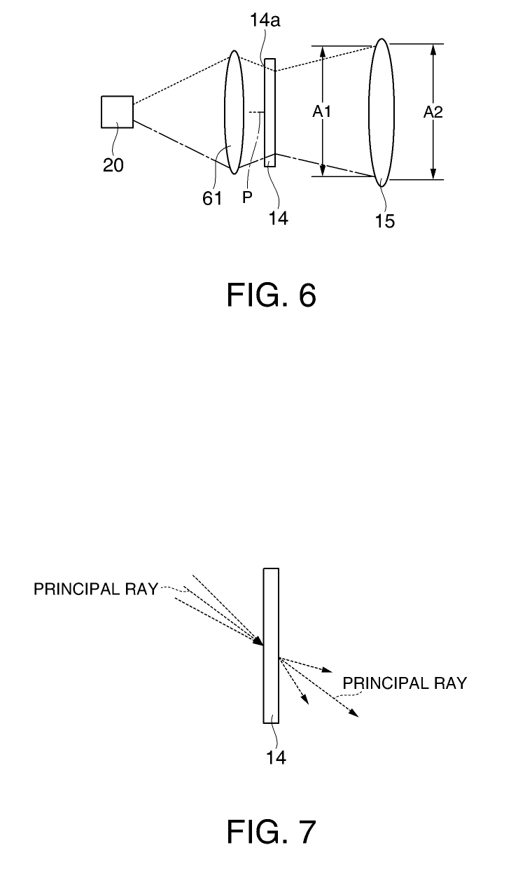

The focusing lens system 61 is disposed, as shown in the enlarged view of FIG. 6, in such a way that an irradiated area A1 of the projection lens 15 that is irradiated with the laser light that has exited from the light diffuser 14 is sized to substantially fill the aperture A2 of the projection lens 15. Using the focusing lens system 61 allows the laser light that has exited from the light diffuser 14 to be diffused with the orientation of the principal rays maintained. In this condition, the intensity of the laser light that has exited from the light diffuser 14 is distributed in such a way that the optical intensity of the principal rays has the highest value, as shown in FIG. 7, and the laser light having the high optical intensity is deflected toward the optical axis O1 of the projection lens 15. In particular, as the deflector, it is preferable to use an element that deflects the laser light incident on the light diffuser 14 in such a way that laser light incident on a position farther apart from the central axis O is deflected more steeply toward the optical axis O1 of the projection lens 15. In this way, the laser light diffused in the light diffuser 14 can be efficiently introduced into the projection lens 15.

The image display apparatus 60 according to the present embodiment can provide the same advantageous effect as that provided in the image display apparatus 1 according to the first embodiment. Further in the image display apparatus 60 according to the present embodiment, since the focusing lens system 61 deflects the laser light that exits from the light diffuser 14 toward the optical axis O1 of the projection lens 15, it is possible to prevent the laser light from not entering the light diffuser 14. The efficiency of light usage can therefore be improved.

Further, since the focusing lens system 61 is disposed between the MEMS mirror 20 and the light diffuser 14, the laser light to be diffused in the light diffuser 14 is deflected toward the optical axis O1 of the projection lens 15 before diffused in the light diffuser 14. Therefore, the size of the aperture of the focusing lens system 61 can be reduced as compared to a case where the focusing lens system 61 is disposed downstream of the light diffuser 14. The size of the overall apparatus can thus be reduced.

Further, since the focusing lens system 61 is used as the deflector, the laser light that exits from the light diffuser 14 can be more reliably deflected toward the optical axis O1 of the projection lens 15.

Moreover, since the focusing lens system 61 is disposed in such a way that the irradiated area A1 of the projection lens 15 that is irradiated with the laser light is sized to substantially fill the aperture A2 of the projection lens 15, the laser light incident on the projection lens 15 will not be wasted. The efficiency of laser light usage can thus be improved. Further, adjusting the position of the focusing lens system 61 in accordance with the size of the aperture A2 of the projection lens 15 allows the size of the irradiated area A1 to be adjusted. The projection lens 15 therefore does not need to have a large aperture A2, whereby the size of the overall apparatus can be reduced.

While the focusing lens system 61 is disposed upstream of the light diffuser 14, the focusing lens system 61 may be disposed downstream of the light diffuser 14. That is, the focusing lens system 61 may deflect the laser light to be incident on the projection lens 15 in such a way that the laser light that has exited from the light diffuser 14 is oriented toward the optical axis O1 of the projection lens 15.

The focusing lens system 61 is used as the deflector, but the deflector is not limited thereto. For example, a liquid crystal device is used to deflect the laser light incident on the projection lens 15 to be oriented toward the optical axis O1 of the projection lens 15.

### Third Embodiment

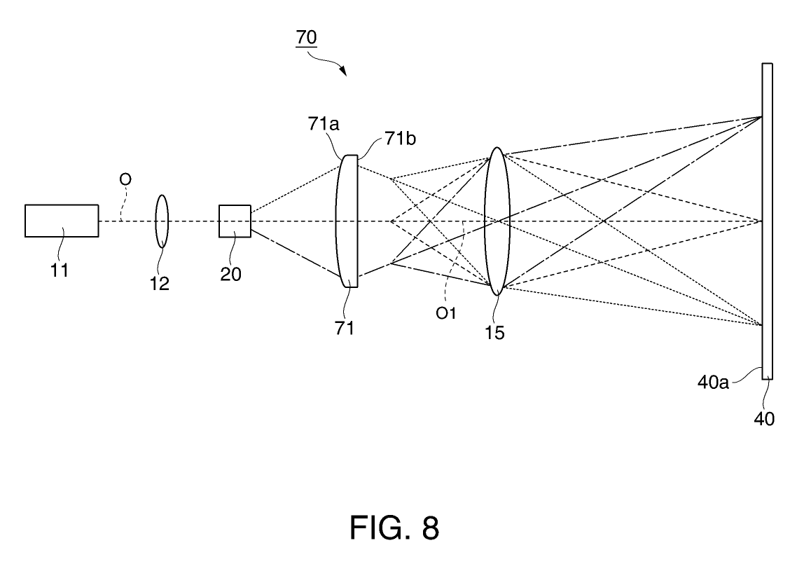

A third embodiment according to the invention will be described with reference to FIG. 8.

An image display apparatus 70 according to the present embodiment is similar to the second embodiment but differs therefrom in terms of the shape of a light diffuser 71.

The light diffuser (divergent angle converter) 71 is integrated with a deflector that deflects exiting laser light toward the optical axis O1 of the projection lens 15, as shown in FIG. 8. The light diffuser 71 is convex on the incident end 71a side and planar on the exit end 71b side. The exit end 71b is a diffusion plane that diffuses the laser light reflected off the MEMS mirror 20. The diffusion plane may be formed by diffusing fine particles therein, or may be comprised of a diffraction element having protrusions and depressions provided therein. The light diffuser 71 is not rotated. In such a configuration, the laser light incident on the light diffuser 71 is deflected by the convex shape on the incident end 71a side in such a way that the exiting laser light is oriented toward the optical axis O1 of the projection lens 15. The laser light is then diffused at the exit end 71b and incident on the projection lens 15.

In the thus configured image display apparatus 70 according to the present embodiment, since the light diffuser 71 is integrated with the deflector, the size of the overall apparatus can be reduced.

The light diffuser 71 may be replaced with a hologram element. That is, a hologram element has a capability of deflecting incident laser light as in the focusing lens system 61 shown in the second embodiment and a light diffusion capability of diffusing and outputting incident laser light. An example of the hologram element may be a computer generated hologram (hereinafter referred to as CGH) in which protrusions and depressions artificially created through computation are formed in a glass substrate. Such a CGH is a wavefront converter that converts the wavefront of incident light using the diffraction phenomenon. In particular, a phase encoded CGH can perform wavefront conversion with nearly all the energy of incident light waves left. A CGH, which can thus produce a uniform intensity distribution or a simply shaped intensity distribution, can be preferably used in the image display apparatus 70. Further, a CGH allows a diffraction grating to be divided into arbitrary areas, and hence can be preferably used without aberrations.

Moreover, the hologram element may have a capability of deflecting the laser light incident on the light diffuser 71 in such a way that laser light incident on a position farther apart from the central axis O is deflected more steeply toward the optical axis O1 of the projection lens 15. In such a configuration, the laser light that has exited from the hologram element can be more efficiently introduced into the projection lens 15, whereby the efficiency in laser light usage can be improved.

The light diffuser 71 maybe rotated as in the second embodiment. In such a configuration, since the speckle pattern is more highly integrated over time, the speckle noise can be reduced more efficiently.

The technical extent of the invention is not limited to the embodiments described above, but a variety of changes can be made to the embodiments to the extent that such changes do not depart from the spirit of the invention.

For example, a hologram element may be used as the divergent angle converters in the first and second embodiments. In such a configuration, the divergent angle θ2 of the laser light that has exited from the MEMS mirror 20 is readily set to a desired value.

The entire disclosure of Japanese Patent Application No. 2007-339461, filed Dec. 28, 2007 is expressly incorporated by reference herein.

What is claimed is:

1. An image display apparatus comprising:
a laser light source that emits laser light;
a focusing optical system that focuses the laser light emitted from the laser light source;
a scanner that scans the light that has exited from the focusing optical system to form an intermediate image;
a divergent angle converter on which the intermediate image is formed, the divergent angle converter enlarging the divergent angle of the incident laser light and outputting the laser light with the enlarged divergent angle; and
a projection element that projects the laser light that has exited from the divergent angle converter toward a surface on which the laser light is projected,
wherein the focusing optical system focuses the laser light onto the divergent angle converter.

2. The image display apparatus according to claim 1,
wherein the divergent angle converter moves in the direction perpendicular to the central axis of the incident laser light.

3. The image display apparatus according to claim 1, further comprising:
a deflector that deflects laser light in such a way that the laser light that exits from the divergent angle converter is oriented toward the optical axis of the projection element.

4. The image display apparatus according to claim 3,
wherein the deflector deflects the laser light in such a way that laser light incident on a position farther apart from the optical axis of the deflector is deflected more steeply toward the optical axis of the projection element.

5. The image display apparatus according to claim 3,
wherein the deflector is disposed between the scanner and the divergent angle converter.

6. The image display apparatus according to claim 3,
wherein the deflector is a lens system.

7. The image display apparatus according to claim 3,
wherein the deflector is disposed in such a way that the irradiated area of the projection element that is irradiated with the laser light that has exited from the divergent angle converter is sized to substantially fill the aperture of the projection element.

8. The image display apparatus according to claim 3,
wherein the divergent angle converter is integrated with the deflector.

9. The image display apparatus according to claim 3,
wherein the divergent angle converter is a hologram element.
